(19) United States
(12) Patent Application Publication
(10) Pub. No.: US 2006/0131283 A1
(43) Pub. Date: Jun. 22, 2006

(54) Method and apparatus for forming angled vias in an integrated circuit package substrate

(75) Inventors: Jeffrey Hall, San Jose, CA (US); Yogendra Ranade, Fremont, CA (US); Sarathy Rajagopalan, Milpitas, CA (US)

Correspondence Address: LSI LOGIC CORPORATION, 1621 BARBER LANE, MS: D-106, MILPITAS, CA, 95035, US

(73) Assignee: LSI Logic Corporation

(21) Appl. No.: 11/016,440

(22) Filed: Dec. 17, 2004

(51) Int. Cl. B23K 26/38

(52) U.S. Cl. 219/121.7; 408/186

(57) ABSTRACT

A method and apparatus for making angled vias in an integrated circuit package substrate includes providing an integrated circuit package substrate having an upper surface and a lower surface. A first position is selected for a first via opening on the upper surface of the package substrate, and a second position is selected for a second via opening on the lower surface of the package substrate. A selected non-vertical angle is determined for forming an angled via through the first position and the second position. The angled via is formed through the first position and the second position at the selected non-vertical angle.

### BACKGROUND OF THE INVENTION

1. Field of the Invention

The method and apparatus disclosed herein for forming angled vias to reduce routing distance in an integrated circuit package substrate is directed to the manufacture of integrated circuits. More specifically, but without limitation thereto, this method is directed to forming vias to connect a first electrically conductive layer on one side of an integrated circuit substrate to a second electrically conductive layer on the opposite side of the integrated circuit substrate.

2. Description of Related Art

Previous methods for forming vias in an integrated circuit package substrate typically include drilling vertical holes through the package substrate and depositing an electrically conductive plating material on the sides of the holes to form an electrical contact between metal layers on the top and bottom surfaces of the package substrate.

### SUMMARY OF THE INVENTION

In an exemplary embodiment, a method of forming a via in an integrated circuit package substrate includes steps of:

(a) providing a package substrate having an upper surface and a lower surface;

(b) selecting a first position for a first via opening on the upper surface of the package substrate;

(c) selecting a second position for a second via opening on the lower surface of the package substrate;

(d) determining a selected non-vertical angle for forming an angled via through the first position and the second position; and

(e) forming the angled via through the first position and the second position of the package substrate at the selected non-vertical angle.

In another embodiment, an apparatus for forming a via in an integrated circuit package substrate includes:

a positioning device for establishing a relative position between a package substrate and a drill; and

a tilting device coupled to the positioning device for selecting a non-vertical angle between the drill and the package substrate to form an angled via through the package substrate at the selected non-vertical angle.

### BRIEF DESCRIPTION OF THE DRAWINGS

The embodiments described herein are illustrated by way of example and not limitation in the accompanying figures, in which like references indicate similar elements throughout the several views of the drawings, and in which:

FIG. 1 illustrates an enlarged side view of a typical via formed in an integrated circuit package substrate according to the prior art;

FIG. 2 illustrates an enlarged side view of an angled via formed in an integrated circuit package substrate;

FIG. 3 illustrates a diagram of a typical reduction in routing distance achieved by replacing the traditional via of FIG. 1 with the angled via of FIG. 2;

FIG. 4 illustrates a side view of a mechanical drill typically used to form a via at a vertical angle as in the example of FIG. 1;

FIG. 5 illustrates a side view of a tilting device for making the angled via of FIG. 2;

FIG. 6 illustrates a top view of the Y-axis control for the tilting device of FIG. 5;

FIG. 7 illustrates a top view of the X-axis control for the tilting device of FIG. 5;

FIG. 8 illustrates a bottom view of the tilting device of FIG. 5;

FIG. 9 illustrates a side view of a tilting drill table for making the angled via of FIG. 2;

FIG. 10 illustrates a diagram for calculating a correction to the position of the package substrate for the X-coordinate for the tilting device of FIG. 5;

FIG. 11 illustrates a diagram for calculating a correction to the position of the package substrate for the Y-coordinate for the tilting device of FIG. 5; and

FIG. 12 illustrates a flow chart of a method of making angled vias in an integrated circuit package substrate.

Elements in the figures are illustrated for simplicity and clarity and have not necessarily been drawn to scale. For example, the dimensions of some elements in the figures may be exaggerated relative to other elements to point out distinctive features in the illustrated embodiments.

### DESCRIPTION OF THE ILLUSTRATED EMBODIMENTS

In previous methods of manufacturing integrated circuit package substrates, plated through holes are drilled perpendicularly to a planar package substrate to electrically connect metal layers formed on the top and bottom surfaces of the package substrate. One of the functions of the package substrate is to provide electrical connections between an integrated circuit die and a motherboard. The integrated circuit die generally has a small footprint and I/O pad pitch, while the motherboard generally has a larger footprint and I/O pad pitch. As a result, signals that are communicated between the die and the motherboard have to be routed outward from the die on the top surface of the package substrate to match the larger footprint and I/O pad pitch on the bottom of the package. A substrate routing scheme using vertical vias, that is, plated through holes, requires a staircase pattern through the package substrate as shown in FIG. 1.

FIG. 1 illustrates an enlarged side view 100 of a typical via formed in an integrated circuit package substrate according to the prior art. Shown in FIG. 1 are a package substrate 102, a top surface 104, a bottom surface 106, a via 108, a bonding wire 110, and a solder ball 112.

In FIG. 1, the via 108 is the vertical portion of a step, and the portions of the metal layers on the top surface 104 and the bottom surface 106 that connect the via to the bonding wire 110 and the solder ball 112 are the horizontal portions of the step. The routing distance of the step formed by the via 108 and the metal layers on the top surface 104 and the bottom surface 106 is given by the sum of the depth of the via 108 plus the distance along the metal layer on the top surface 104 to the bonding wire 110 plus the distance along the metal layer on the bottom surface 106 to the solder ball 112. Consequently, the routing distance depends on the thickness of the package substrate 102 as well as the difference in footprint size and I/O pad pitch between the die and the motherboard. In some applications, the performance of the die may be limited by the routing distance, therefore it may be advantageous and even necessary to reduce the routing distance to meet the performance specifications of the integrated circuit design. By reducing the footprint size and the I/O pad pitch of the integrated circuit package, the routing wire length may be reduced accordingly, however, the smaller package may be more difficult to position properly on the motherboard without costly modifications to the assembly tools.

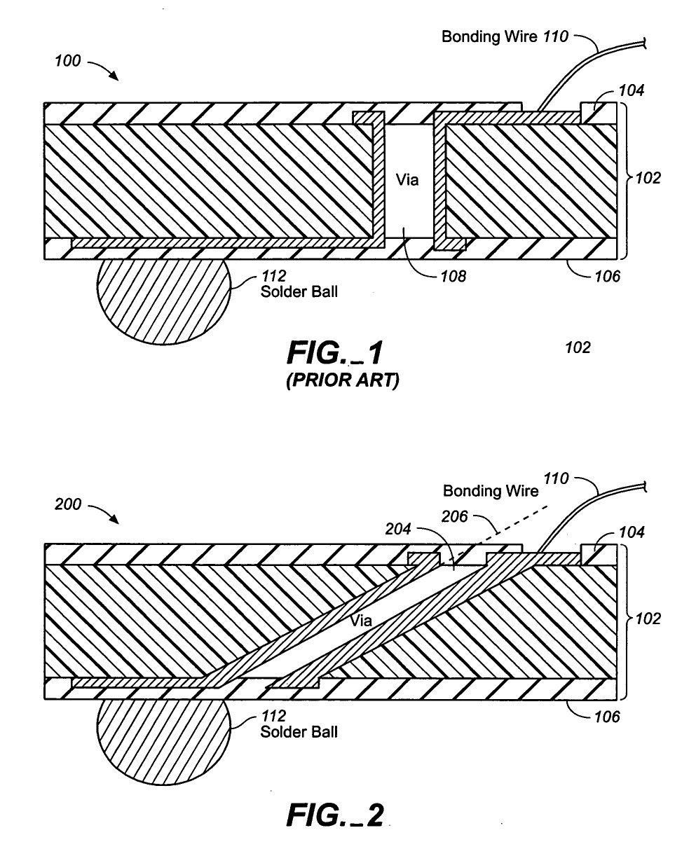

Another approach to reducing the routing distance in a package substrate is to form the vias at an angle through the package substrate directly between the points to be connected on the die and the motherboard as shown in FIG. 2.

FIG. 2 illustrates an enlarged side view 200 of an angled via formed in an integrated circuit package substrate. Shown in FIG. 2 are a package substrate 102, a top surface 104, a bottom surface 106, an angled via 204, a via angle 206, a bonding wire 110, and a solder ball 112.

In FIG. 2, the via angle 206 from the perpendicular to the package substrate 102 is selected to achieve the minimum routing distance between the bonding wire 110 and the solder ball 112 while still maintaining the proper footprint size and I/O pad pitch needed for manufacturability and electrical signal integrity. The via angle 206 may also be selected according to well known techniques to avoid design bottlenecks that are frequently encountered by routing schemes using vertical vias. The angled via 204 may also be used with package substrates that are connected to flip-chip dies by solder bumps and package substrates that are connected to dies by other connection methods.

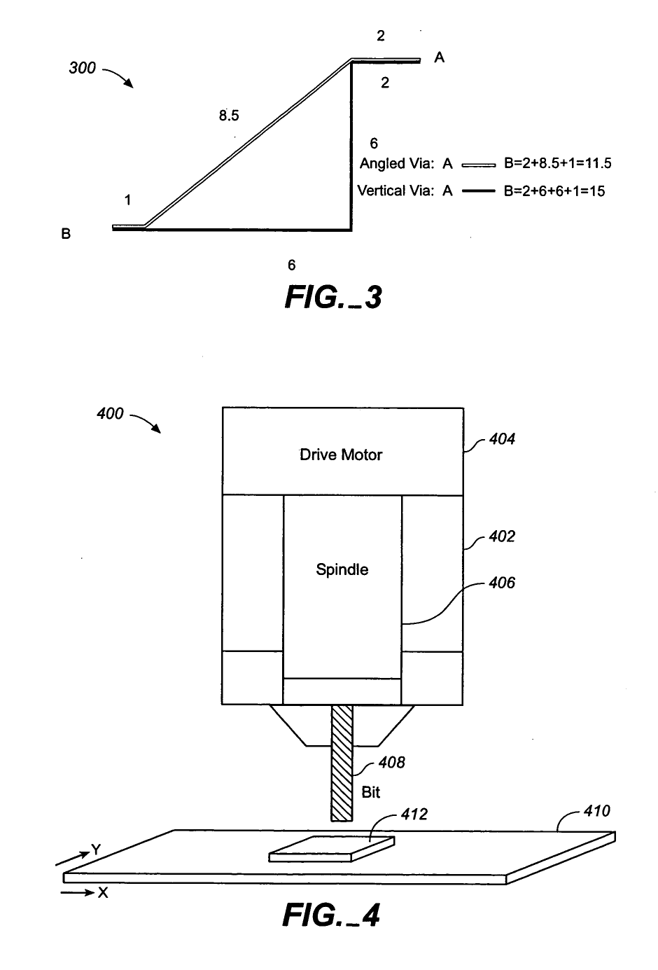

FIG. 3 illustrates a diagram 300 of a typical reduction in routing distance achieved by replacing the traditional via of FIG. 1 with the angled via of FIG. 2.

In FIG. 3, the routing distance between points A and B using the vertical via is 15 units, while the routing distance between points A and B using the angled via is only 11.5 units, advantageously providing a substantial reduction in routing distance without altering the footprint of the substrate package.

FIG. 4 illustrates a side view 400 of a mechanical drill typically used to form a via at a vertical angle as in the example of FIG. 1. Shown in FIG. 4 are a fixed mount 402, a drive motor 404, a spindle 406, a drill bit 408, a mechanical table 410, and a package substrate 412.

In FIG. 4, the fixed mount 402 holds the drive motor 404, the spindle 406, and the drill bit 408 in a fixed position perpendicular to the mechanical table 410. The mechanical table 410 is translated in the X-Y position plane according to well known techniques, for example, by leadscrews attached to stepping motors (not shown). The mechanical table 410 moves under the drill bit 408 to position the integrated circuit package substrate 412 to each location in the X-Y axes of the position plane where a via is to be drilled.

In one embodiment, an apparatus for forming an angled via in an integrated circuit substrate includes:

a positioning device for establishing a relative position between an integrated circuit package substrate and a drill; and

a tilting device coupled to the positioning device for selecting a non-vertical angle between the drill and the package substrate to form an angled via through the package substrate at the selected non-vertical angle.

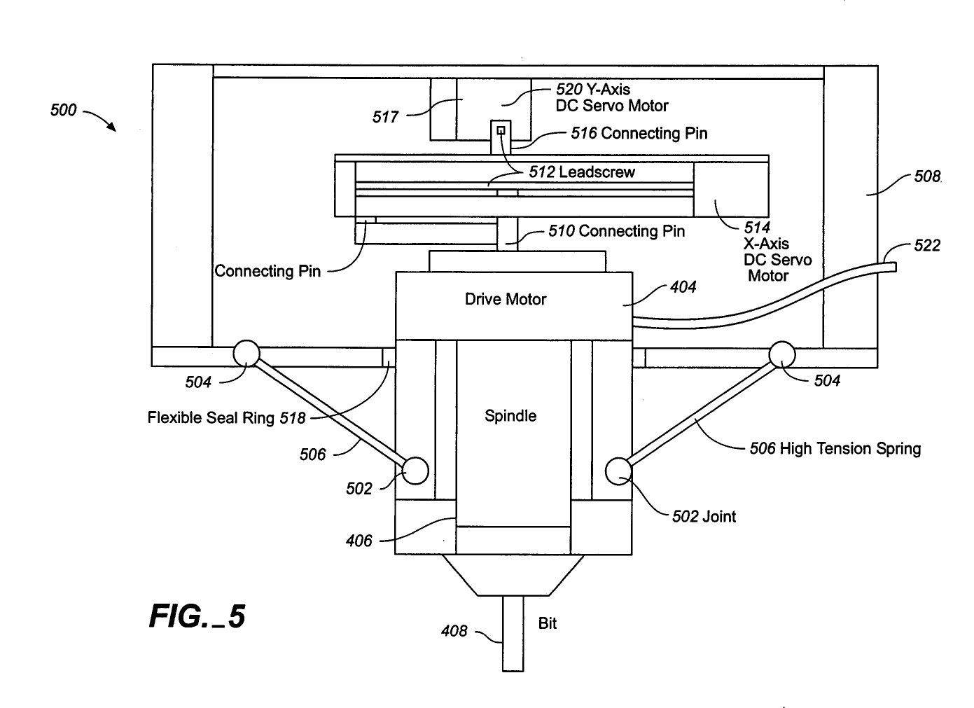

FIG. 5 illustrates a side view 500 of a tilting device for making the angled via of FIG. 2. Shown in FIG. 5 are a drill housing 402, a drive motor 404, a spindle 406, a drill bit 408, lower swivel joints 502, upper swivel joints 504, tension springs 506, a swivel base 508, an X-axis connecting pin 510, an X-axis leadscrew 512, an X-axis servo motor 514, a Y-axis connecting pin 516, Y-axis leadscrew 517, a flexible seal ring 518, a Y-axis servo motor 520, and an electrical supply cable 522.

In FIG. 5, a drill assembly including the drive motor 404, the spindle 406, and the drill bit 408 are swiveled inside the flexible seal ring 518 from an opening in the swivel base 508 on the lower swivel joints 502. Alternatively, the drill assembly may be a laser drill or any other type of drill suitable for forming vias in a package substrate. The electrical supply cable 522 is preferably a flexible electrical cable suitable for supplying electrical power to the drill assembly while allowing the drill assembly to swivel from the swivel base 508.

The lower swivel joints 502 are attached to the lower half of the drill assembly. The tension springs 506 connect the lower swivel joints 502 to the upper swivel joints 504 that are fastened to the swivel base 508. The tension springs 506 hold the drill assembly in the center of the opening in the swivel base 508 at a selected angle.

The selected angle is achieved by moving the X-axis connecting pin 510 fastened to the top end of the drill assembly. The X-axis connecting pin 510 moves along the X-axis leadscrew 512 that is rotated by the X-axis servo motor 514. The X-axis leadscrew 512 and the X-axis servo motor 514 are connected to the Y-axis connecting pin 516. The Y-axis connecting pin 516 moves along the Y-axis leadscrew 517 that is rotated by the Y-axis servo motor 520. The Y-axis leadscrew 517 and the Y-axis servo motor 520 are mounted to the swivel base 508 to provide a reference location from which the top end of the drive motor 404 is translated in the X-Y position plane to swivel the drill assembly to the selected angle.

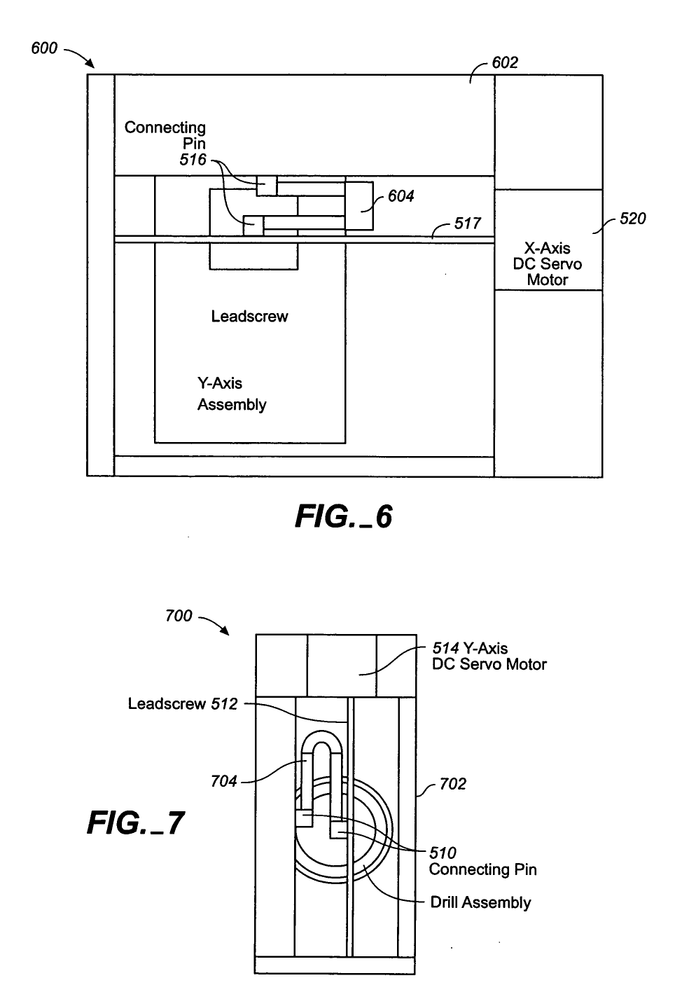

FIG. 6 illustrates a top view 600 of the Y-axis control for the tilting device of FIG. 5. Shown in FIG. 6 are a Y-axis connecting pin 516, a Y-axis leadscrew 517, a Y-axis servo motor 520, a Y-axis control housing 602, and a Y-axis leadscrew sensor cable 604.

In FIG. 6, the Y-axis leadscrew 517 and the Y-axis servo motor 520 are mounted on the Y-axis control housing 602 according to well known mechanical techniques. The Y-axis leadscrew sensor cable 604 is used to communicate the position of the Y-axis connecting pin 516 along the Y-axis leadscrew 517 to the servo motor 520.

FIG. 7 illustrates a top view 700 of the X-axis control for the tilting device of FIG. 5. Shown in FIG. 7 are an X-axis connecting pin 510, an X-axis leadscrew 512, an X-axis servo motor 514, an X-axis control housing 702, and an X-axis leadscrew sensor cable 604.

In FIG. 7, the X-axis leadscrew 512 and the X-axis servo motor 514 are mounted on the X-axis control housing 702 according to well known mechanical techniques. The X-axis leadscrew sensor cable 704 is used to communicate the position of the X-axis connecting pin 510 along the X-axis leadscrew 512 to the servo motor 514.

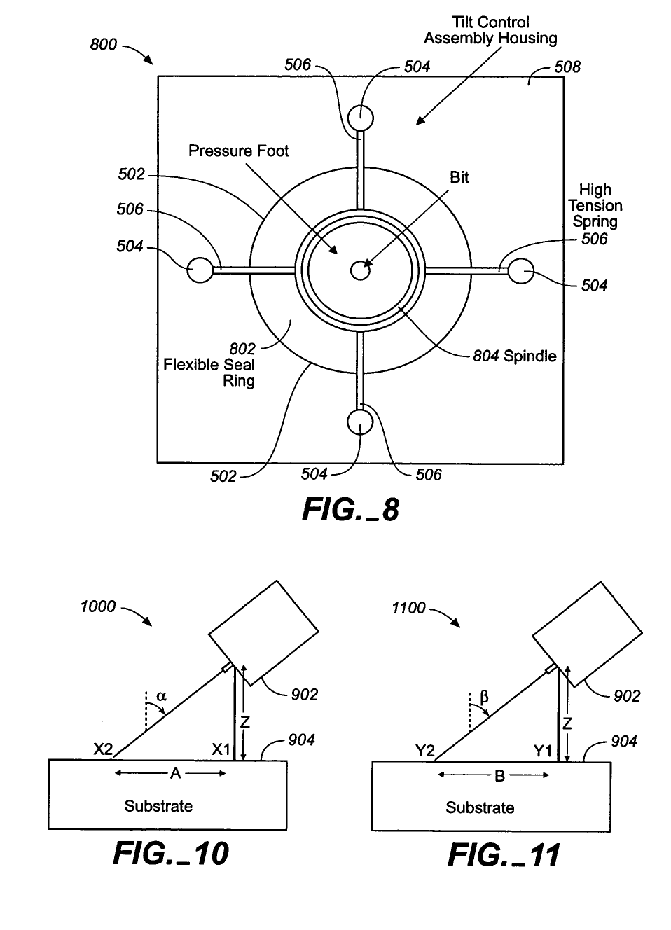

FIG. 8 illustrates a bottom view 800 of the tilting device of FIG. 5. Shown in FIG. 8 are lower swivel joints 502, upper swivel joints 504, tension springs 506, a swivel base 508, a flexible seal ring 802, and a drill assembly 804.

In FIG. 8, the drill assembly 804 swivels inside the flexible seal ring 802 through an opening in the swivel base 508. The flexible seal ring 802 prevents debris from fouling the drill assembly and helps damp vibrations from the drill assembly 804. The drill assembly 804 is held in the center of the flexible seal ring 802 by the tension springs 506 between the lower swivel joints 502 and the upper swivel joints 504 as the drill assembly 804 is tilted to the selected angle.

The same mechanical table used with the vertical via drill of FIG. 4 may be used to position the package substrate under the tilting device of FIG. 5. Alternatively, the tilting device may be mounted on the mechanical table according to well known techniques to move the drill assembly to various positions relative to a stationary package substrate. In another embodiment, the mechanical table may be tilted by the selected via angle relative to a stationary drill assembly.

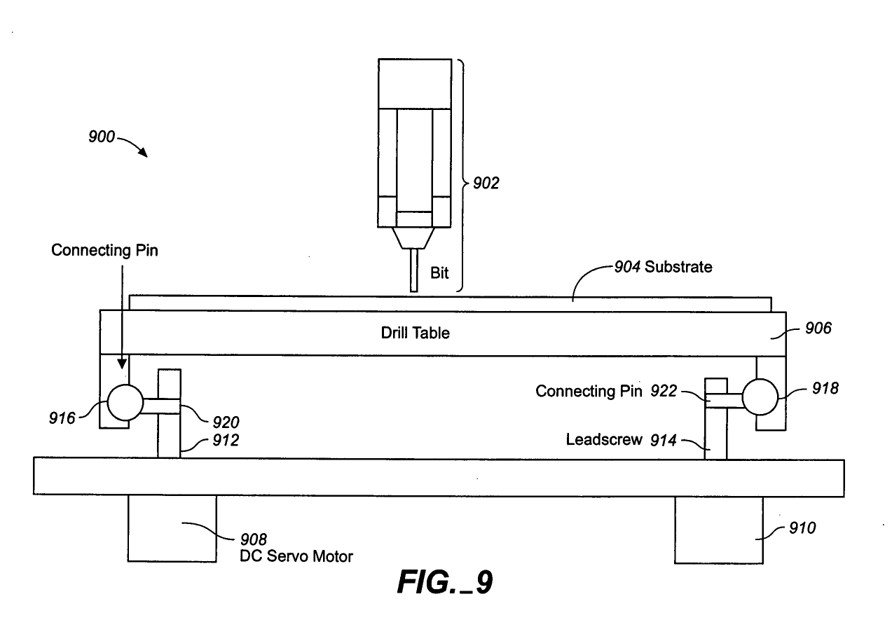

FIG. 9 illustrates a side view 900 of a tilting drill table for making the angled via of FIG. 2. Shown in FIG. 9 are a drill assembly 902, a package substrate 904, a tilting drill table 906, servo motors 908 and 910, leadscrews 912 and 914, swivel joints 916 and 918, and connecting pins 920 and 922.

In FIG. 9, the drill assembly 902 may be a mechanical drill, for example, the drive motor 404, spindle, 406, and drill bit 408 of FIG. 5, or the drill assembly 902 may be a laser drill. Alternatively, the drill 902 may be any other type of drilling tool used for forming vias in a package substrate. In this example, the drill 902 is fixed to a stationary mount (not shown). The tilting drill table 906 is tilted to the selected angle by the servo motors 908 and 910. The servo motors 908 and 910 turn the leadscrews 912 and 914 in opposite directions to achieve the height difference needed between the connecting pins 920 and 922 to set the selected angle. The connecting pins 920 and 922 couple the tilting drill table 906 to the leadscrews 912 and 914, and the swivel joints 916 and 918 rotate on the connecting pins 920 and 922 as one end of the tilting drill table 906 moves up one of the leadscrews 912 and 914 while the other end of the tilting drill table 906 moves down the other one of the leadscrews 912 and 914. A mechanical table may be mounted on the tilting drill table according to well known mechanical techniques to move the package substrate to the position of each via on the package substrate.

Because the drill assembly is tilted at a selected non-vertical angle from the Z-axis, a correction is needed to the via coordinates so that the entry point of the drill coincides with the desired location of the via opening on the top of the package substrate at the selected non-vertical angle. The correction to the via coordinates may be calculated as a function of the selected angle, for example, as described below.

FIG. 10 illustrates a diagram 1000 for calculating a correction to the position of the package substrate for the X-coordinate for the tilting device of FIG. 5. Shown in FIG. 10 are a drill assembly 902, a package substrate 904, an initial height Z, a corrected X-coordinate X1, an entry X-coordinate X2, and an X-coordinate correction A.

In FIG. 10, the entry X-coordinate X2 is the location where the via opening would be formed in the top metal layer of the package substrate 904 when the drill assembly 902 is positioned at the corrected X-coordinate X1. The drill 902 has an initial height Z from the package substrate measured from perpendicular to the package substrate 904. The perpendicular to the package substrate 904 is also referred to as the Z-axis. The drill 902 is tilted from the perpendicular Z-axis by the projection of the selected angle on the X-axis. The X-coordinate correction A is given by
A=Z tan α (1)
where α is the projection of the selected angle on the X-axis. The corrected X-coordinate X1 is calculated by adding the X-coordinate correction A to the entry X-coordinate X2 according to
X1=X2+A (2)

If α is negative, that is, measured from the left side of the Z-axis, then the X-coordinate correction A is also negative according to formula (1). An additional correction may be included in the X-coordinate correction A if needed depending on the type of drill used.

FIG. 11 illustrates a diagram 1100 for calculating a correction to the position of the package substrate for the Y-coordinate for the tilting device of FIG. 5. Shown in FIG. 11 are a drill 902, a package substrate 904, an initial height Z, a reference Y-coordinate Y1, an entry Y-coordinate Y2, and a Y-coordinate correction B.

In FIG. 11, the entry Y-coordinate Y2 is the location where the via opening would be formed in the top metal layer of the package substrate 904 when the drill assembly 902 is positioned at the reference Y-coordinate Y1. The drill 902 has an initial height Z from the package substrate measured on the Z-axis. The drill 902 is tilted from the perpendicular Z-axis by the projection of the selected angle on the Y-axis. The Y-coordinate correction B is given by
B=Z tan β (3)
where β is the projection of the selected angle on the Y-axis. The corrected Y-coordinate Y1 is calculated by adding the Y-coordinate correction B to the entry Y-coordinate Y2 according to
Y1=Y2+B (4)

If β is negative, that is, measured from the left side of the Z-axis, then the Y-coordinate correction B is also negative according to formula (3). An additional correction may be included in the Y-coordinate correction B if needed depending on the type of drill used.

The calculated X-coordinate and Y-coordinate corrections may be added to the via coordinates for each via respectively to determine the position of the drill assembly relative to the package substrate for each selected non-vertical via angle. Alternatively, a lookup table of X-coordinate and Y-coordinate corrections may be generated for a range of selected non-vertical via angles for a given drill height Z according to well known techniques in trigonometry. The X and Y coordinate corrections may be found from the lookup table for a selected via angle and added to the via coordinates to determine the position of the drill assembly relative to the package substrate for each selected non-vertical via angle.

Other arrangements may be used to tilt the drill assembly to the selected angle according to well known mechanical techniques to practice various embodiments of the apparatus for making angled vias within the scope of the appended claims.

The method and apparatus described above for making angled vias may be used in conjunction with well established techniques for verifying via position accuracy, burr removal, desmear, electroless and electrolytic copper plating, and plating inspection for thickness, protrusions, and pinholes.

In another embodiment, a method of making angled vias in an integrated circuit package substrate includes steps of:

(a) providing a package substrate having an upper surface and a lower surface;

(b) selecting a first position for a first via opening on the upper surface of the package substrate;

(c) selecting a second position for a second via opening on the lower surface of the package substrate;

(d) determining a selected non-vertical angle for forming an angled via through the first position and the second position; and

(e) forming the angled via through the first position and the second position of the package substrate at the selected non-vertical angle.

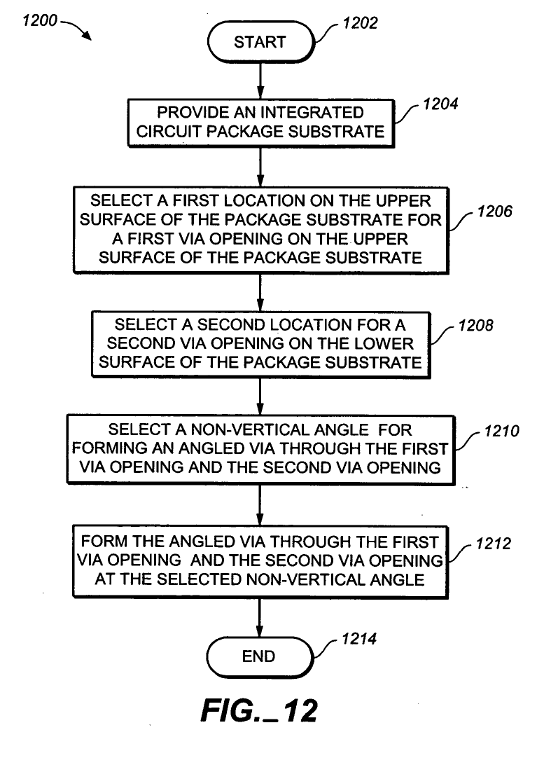

FIG. 12 illustrates a flow chart 1600 of a method of making angled vias in an integrated circuit package substrate.

Step 1202 is the entry point of the flow chart 1200.

In step 1204, an integrated circuit package substrate is provided. The package substrate has an upper surface used for making connections to an integrated circuit die and a lower surface used for making connections to a motherboard.

In step 1206, a first location on the upper surface of the package substrate is selected for a first via opening on the upper surface of the package substrate. The first via opening is preferably located as close as possible to the bonding wire or flip chip bump used to connect the package substrate to the die.

In step 1208, a second location is selected for a second via opening on the lower surface of the package substrate. The second via opening is preferably located as close as possible to the solder bump used to connect the package substrate to the motherboard. By locating the via openings close to the points that are to be electrically connected, the wire distance between them compared to that using a vertical via is reduced by the maximum amount.

In step 1210, a non-vertical angle is selected for forming an angled via through the first via opening and the second via opening. The selected non-vertical angle may be calculated according to well known techniques of trigonometry, for example, by calculating the arctangent of the ratio of the coordinate distance between the first via opening and the second via opening and the thickness of the package substrate. The angled via may be formed, for example, using a tilting drill assembly as described above.

In step 1212, an angled via is formed through the first via opening and the second via opening at the selected non-vertical angle. The angled via may be formed, for example, by a mechanical drill, a laser drill, or by any other drill suitable for forming vias in an integrated circuit package substrate.

Step 1214 is the exit point of the flow chart 1200.

Although the methods illustrated by the flowchart description above is described and shown with reference to specific steps performed in a specific order, these steps may be combined, sub-divided, or reordered without departing from the scope of the claims. Unless specifically indicated herein, the order and grouping of steps is not a limitation of other embodiments within the scope of the claims.

The specific embodiments and applications thereof described above are for illustrative purposes only and do not preclude modifications and variations that may be made thereto by those skilled in the art within the scope of the following claims.

What is claimed is:

1. A method comprising steps of:
(a) providing a package substrate having an upper surface and a lower surface;
(b) selecting a first position for a first via opening on the upper surface of the package substrate;
(c) selecting a second position for a second via opening on the lower surface of the package substrate;
(d) determining a selected non-vertical angle for forming an angled via through the first position and the second position; and
(e) forming the angled via through the first position and the second position of the package substrate at the selected non-vertical angle.

2. The method of claim 1 wherein step (e) comprises forming the angled via with a mechanical drill.

3. The method of claim 1 wherein step (e) comprises forming the angled via with a laser drill.

4. The method of claim 1 wherein step (d) comprises calculating an arctangent of a ratio of a coordinate distance between the first via opening and the second via opening and a thickness of the package substrate.

5. The method of claim 1 wherein step (e) comprises calculating a correction to the first location so that the entry point of a drill for forming the angled via coincides with the first location at the selected non-vertical angle.

6. An apparatus comprising:
a positioning device for establishing a relative position between an integrated circuit package substrate and a drill; and
a tilting device coupled to the positioning device for selecting a non-vertical angle between the drill and the package substrate to form an angled via through the package substrate at the selected non-vertical angle.

7. The apparatus of claim 6 wherein the positioning device comprises a mechanical table.

8. The apparatus of claim 6 wherein the tilting device comprises a tilting drill assembly.

9. The apparatus of claim 6 wherein the tilting device comprises a tilting drill table.

10. The apparatus of claim 6 wherein the drill is a mechanical drill.

11. The apparatus of claim 6 wherein the drill is a laser drill.
